(19) United States
(12) Patent Application Publication
(10) Pub. No.: US 2007/0104949 A1
(43) Pub. Date: May 10, 2007

(54) Granulate made of sintered or cellular broken glass

(75) Inventor: Rainer Bunge, ZURICH (CH)

Correspondence Address: BUCHANAN, INGERSOLL & ROONEY PC, POST OFFICE BOX 1404, ALEXANDRIA, VA, 22313-1404, US

(73) Assignee: MISAPOR AG, LANDQUART (CH)

(21) Appl. No.: 10/561,525

(22) PCT Filed: Jun. 21, 2004
(86) PCT No.: PCT/CH04/00377

§ 371 Date: Oct. 2, 2006

(30) Foreign Application Priority Data
Jun. 20, 2003 (CH) 1091/03
Sep. 2, 2003 (CH) 1500/03

(51) Int. Cl. B32B 5/16; B32B 15/02; C03B 19/00; C04B 5/00; C03B 19/08

(52) U.S. Cl. 428/402; 428/406; 65/17.6; 65/20; 65/22

(57) ABSTRACT

A granulate that consists of broken pieces of a sintered body that is sintered from crushed blow-molded glass has a number of inclusions of at least one active substance on the broken surfaces of granulate. This active substance is embedded as a grain in sintered body. Upon contact with toxins, in particular with toxins that are suspended or dissolved in water, this active substance can interact with these toxins. Such a granulate can be produced very readily relative to active substance, compressive strength, specific weight, grain size, etc., and can be used correspondingly in a versatile manner. Despite arsenic- or antimony-containing starting substances, it can be used, for example, in the form of foam glass broken pieces as a construction material in environmentally-sensitive areas. It can be used, e.g., in the form of expanded or unexpanded sintered bodies in water purification. Depending on the intended use, metals, in particular metallic iron, active carbon or else water-soluble substances, can be used as active substances.

The invention relates to a granulate and a bulk material with or consisting of such a granulate. The granulate is produced by sintering crushed blow-molded glass into a sintered body and then breaking the body into fragments.

The invention also relates to a bulk material with broken foam glass fragments, in whose glass starting material (e.g., scrap glass), toxins, in particular antimony and/or arsenic, could be fixed.

The invention relates in particular to a bulk material for water purification. The bulk material for the water purification contains a granulate that consists of fragments of a sintered body that is sintered from crushed blow-molded glass, in particular a broken granulate of a foam glass, or the bulk material consists completely of such a granulate.

In this document, sintered body is defined as a heat-sintered body that consists of blow-molded glass fragments. In this body, the original parts remain essentially stationary during sintering. After the sintering, the fragments are connected to one another at least via bridges. Between the sintered fragments of the blow-molded glass in this case, there are cavities that, depending on the design of the sintering, are designed in an interconnecting, partially interconnecting or closed-cell manner. Foam glass is defined as a special form of such a sintered body.

Foam glass pearls are known from JP-A-61048441. The latter are produced by a combustible nuclear material being sheathed. The sheathing consists alternately of a layer of a glass powder/foaming agent mixture and a layer of metal powder, especially iron powder. For forming the sheathing, a binder is required. The layer comprises at least one metal layer inside a glass powder layer. By heating action, the nuclear material is combusted, and the glass is foamed. Hollow pellets are thus produced with a foam glass jacket, in which a metal layer is embedded.

A foam glass that is produced from natural, vitreous minerals, such as obsidian, perlite, volcanic rock, shirasu, etc., is known from JP-A-63144144. As a foaming agent, a metal carbonate, for example calcium carbonate or magnesium carbonate, a nitrate such as potassium nitrate, and carbon, SiC, etc., is added to this mineral. To obtain, at lower temperature, a foam glass that has a low water resorption and a high resistance to water, the natural vitreous mineral in a certain grain size is mixed with the foaming agent and with sodium hydroxide, iron powder and water, dried at 200 degrees and foamed by heating.

A sound-insulating material that consists of a foamed material, e.g., foam, foamed liquid glass or a foam element made of volcanic glass or foam glass, is known from JP 52096501. This foam element contains a metal in powder form or as fibers. As metals, there are described: lead, zinc, tin, iron, aluminum, and copper.

A glass product and a process as well as a mixture for the production of the glass product are known from DE-A-2334101. In the process, container glass with covers, closures and labels is crushed and sintered in a form, whereby the glass particles do not melt and therefore the product obtains a characteristic colored appearance. During the sintering, the glass particles can be pressed, or the particle mixture can be foamed. In this case, the glass particles grow together into a mass but remain identifiable.

For sintering, a treatment agent that preferably consists of pulverized, heat-treated excrements is necessary. As a result, a high-grade product is produced from waste products with an inexpensive process.

This glass product contains a metal portion that consists of the metal portions that are crushed together with the glass. This metal portion comprises 0.1 to 3% by weight of iron, but also tin (0.1 to 2%), aluminum (0.1 to 2%), and other metals (0.1 to 2%). Moreover, cellulose derivatives and other organic substances are contained in the glass powder, since the hollow glasses that are used are ground in an unpurified and unsorted state.

The foam glass production from blow-molded glass in general and from scrap glass in particular is prior art and is documented in detail in the literature. The use of scrap glass and glass wastes in the foam glass production in this case represents an advantageous and non-polluting use of wastes. The foam glass production takes place in general in the following steps:
Crushing of the blow-molded glass to about 0.1 mm (production of “glass powder”)
Admixing a gas-releasing chemical during heating (as a “foam”) to produce glass powder
Melting of the power mixture that consists of glass powder and foams by heat action at about 900° C.
Reboiling and “baking” of the glass over about 10 minutes
Cooling of the foam glass element that is produced
Manufacturing, e.g., cutting up or granulating, the crude foam glass element

Foam glass, which is produced from a glass powder that contains a powder mixture and a foaming agent in powder form that forms gas under heat action is closed-cell. Such a foam glass is known from, for example, EP-A-0 292 424 (Misag AG). Such processes for the production of foam glass lumps have proven their value and can be assimilated on a large industrial scale. Thus, recycling glasses of virtually any origin can be processed into a high-grade product. The foam glass lumps are achieved by foaming a melting powder layer and breaking the thus formed foam glass layer. The breakage of the foam glass layer takes place spontaneously by cooling. The spontaneously forming grain size corresponds approximately to the layer thickness.

Such foam glass lumps have a bulk density of about 250 kg/m3, whereby heavier and lighter foam glass can also be produced. Foam glass lumps with closed pores float in the water. Since foam glass is closed-cell and water-tight, the pores are not filled with water, so that the lifting force does not lessen over time. The foam glass has a high compressive strength of, on the average, 6 N/mm2. The compressive strength is also probably between about 1 N/mm2 and about 10 N/mm2. The pore size, the pore density and the wall strength of the pores can be adjusted with the composition of the powder mixture. The finer, e.g., the foaming agent is pulverized, the smaller the pore size. Such a foam glass is used in the construction sector as a perimeter insulation, as a seepage layer, as a light-weight feedstock on a low-strength base, and as a light additive for a high-performance light-weight concrete according to EP-A-1 183 218 (Misapor AG).

Depending on the composition of the blow-molded glass used, toxins can be introduced into the foam glass with the latter. In particular, the semi-metals antimony and arsenic that are used in glazes and optical glasses are also found again and again in separately collected scrap glass from households, although only in very small amounts.

It was previously assumed that foam glass, as the glass that is used in this respect, is an inert substance. In the Swiss “Technische Verordnung über Abfälle [Technical Ordinance on Wastes]” (TVA), Appendix 1, that which in Switzerland is considered to be an inert substance is defined. It is cited therein that a substance only is considered to be an inert substance if, i.a., a boundary value of 0.01 mg of arsenic per liter is not exceeded in its acid eluate. A boundary value for antimony is not determined. Glass and glass wastes are considered to be inert substances according to this ordinance, since they adhere to the required boundary values therein.

As our tests showed, surprisingly enough, however, even the least traces of antimony or arsenic, which are originally present in the inert scrap glass in largely immobile form, can be mobilized by the process of foam glass production from this inert glass.

An eluate was made according to the Swiss “Technische Verordnung über Abfälle” (TVA) of a pulverized rough glass with an average grain size of about 0.1 mm and an antimony content of 0.86 mg/kg. In this eluate, a content of antimony of below 0.005 mg/l was measured. A foam glass was produced from this rough glass. The foam glass was granulated to a grain size of about 4 mm. In turn, an eluate was produced according to TVA from this granulate. In this eluate of the foam glass, 0.052 mg of antimony per liter of eluate was measured. Analogous effects were observed for arsenic, for which the TVA determines a boundary value of 0.01 mg per liter of eluate.

The toxin antimony or arsenic that is contained in the rough glass or the glass structure thus is obviously converted by the process of foam glass production such that the toxin can be washed out upon contact with water from the foam glass. The possibilities for use of such a non-inert foam glass as a structural material in environmentally-sensitive applications, e.g., in water engineering, are greatly limited.

The washing-out of antimony and arsenic occurs only where foam glass comes into contact with water. The larger the surface area of the foam glass, the larger the surface area from which these toxins can pass into water. In a bulk material that consists of broken foam, the cells on the surface of the foam glass lump are open. The surface area is therefore very large. On account of other parameters, however, a bulk material that consists of broken foam glass lumps is very well suited for, for example, building gravity-feed drains and roads on swampy, unstable ground, perimeter insulations, concrete production, in particular for concrete walls resting against dirt. The bulk material must therefore be suitable for contact with water.

The described problem is not known from the relevant literature. Also, the reason for this observed change has not yet been studied. Therefore, there is also no documented solution set for preventing or reducing this problem of antimony and arsenic washing out of foam glass.

A process for treating arsenic-containing waste water, in which this waste water is directed through a substrate that contains metallic iron (U.S. Pat. No. 6,387,276, University of Connecticut), under anaerobic conditions, is known. The patent provides no indication whatsoever, however, of how a washing-out of arsenic or even a washing-out of antimony from substrates that are loaded with these toxins could be prevented.

The technology of the waste-water purification by means of metallic iron is largely known and can be divided into four groups depending on the type of contact between the iron and the waste water:

Group 1: Process in which powdery iron is stirred into the waste water. Such processes are described in JP-A-01307497 for phosphorus removal, in U.S. Pat. No. 5,575,919 for arsenic setting through iron and sulfur powder, and in U.S. Pat. No. 5,906,749 for copper removal from acidic waste water. In this process, it is disadvantageous in particular in that then sedimentation is necessary, in which the toxin-containing iron sludge that is produced must be separated.

Group 2: Process in which iron powder is introduced as a feedstock through which waste water flows. Such processes are described in JP-A-08257570 for the removal of heavy metals and organochlorine compounds and as an embodiment that is preferred in practice with a mixture that consists of iron chips and sand in U.S. Pat. No. 6,387,276. In this process, an optimizing conflict exists. On the one hand, the iron should be as fine-grained as possible to present a high specific surface area; on the other hand, the iron powder must be coarse-grained enough so that the layer remains sufficiently readily percolatable. It is also disadvantageous that the finer pores of the feedstock “increase” by the formation of rust. In processes that operate with inert additives for “diluting” the iron feedstock, separation phenomena must be expected when the reactors are filled and operated.

Group 3: Processes in which the iron powder is moved. Such a process is described in U.S. Pat. No. 5,133,873 (fluidized bed). Another process, in which the iron granulate is moved by vibration or by stirring, is described in WO0110786. By this process, the formation of sinter-like agglomerations of the particles by rust can be avoided, but the processing is expensive. Then, in any case (as in group 1), a sedimentation of the sludge that is discharged from the fluidized bed must be carried out.

Group 4: Process in which extremely fine-grained iron is anchored to a carrier. The waste-water treatment with ultra-fine-grained iron particles (diameter 5-50 nm), which are anchored to silica gel, is known from U.S. Pat. No. 6,242,663.

EP-A-0 436 124 discloses a filter pad with fine-grained iron particles that are anchored to a mineral carrier. In addition to the iron powder and additives, the carrier contains a binder (e.g., cement) and is reboiled to provide a large specific surface area. The structure is essentially open-cell. In this filter material, the circumstance that the binding agent is in general strongly alkaline, which excludes use in the area of drinking water, is disadvantageous. Also problematic is the circumstance that the mechanical strength of the granulate is low, in any case if a higher proportion of pores exists. In addition, filtration elements with mineral binding agents do not have a long service life, since these binding agents are not fully water-insoluble. In particular, virtually all known mineral binding agents are strongly attacked by acids.

From DE-A-195 31 801 and from DE-A-197 34 791, processes with which an open-cell expanded-glass granulate can be produced are known. It is common to the processes that a powder mixture that mainly contains glass powder is wetted and is granulated into a granulate of a grain size of 0.8 to 4 or 1 to 4 mm. The granulate is then sintered.

As pore formers, various additives can be used. For example, melting wax pellets, washable salts or gas-forming expansion agents are cited.

Disadvantageous in such preformed and then sintered pellets is their low compressive strength, their spherical shape, and in particular the expensive production process.

DE-A-198 17 268 refers to the two above-mentioned publications and describes a process for catalytic and biological waste-water purification as well as a granulate for performing the process. A granulate with pores with an average diameter of 42 μm is used. The walls of the macropores are coated by immersing the granulate in an iron salt solution and subsequent tempering with Fe₂O₃. This iron oxide constitutes about 5% by mass of the granulate. This granulate is used for a catalytic and biological waste-water purification. The biological and the catalytic processes are performed at the same time in the pores of the open-cell element. This open-cell element consists of an expanded-glass granulate (e.g., a granulate according to DE-A-195 31 801 or DE-A-197 34 791), zeolite or ceramic, whereby it is claimed that the catalytically active substances (e.g., iron) are embedded in the granulate material or are applied to the pore surface. The description does not give any indication how the substances can be embedded differently in the basic material than by the described application to the pore wall.

With such a granulate, with the addition of H₂O₂, toxins that are difficult to degrade are oxidized, whereby the reaction products of this oxidation in direct physical proximity can be degraded by the microorganisms. As toxins that can be readily degraded with this process, p-chlorophenol and organic substances are indicated. The degradation of the organic substances is indicated based on the organically bonded total carbon.

The object of the invention is to propose a granulate that can be used in many ways and a bulk material that consists of or is with this granulate. The granulate is to be non-polluting, advantageous in production, and producible from waste products. It is to be possible to produce the granulate in a quality with high compressive strength.

This object is achieved by the subject of claim 1. The granulate that consists of fragments of a sintered body that is sintered from crushed blow-molded glass with a number of inclusions of at least one active substance on the broken surfaces of the granulate can be produced with conventional processes and in an extremely pressure-resistant quality. The active substance is embedded as a grain in the sintered body. Owing to the active substance, which can occur in interaction with the toxin upon contact with toxins that are suspended or dissolved in particular in water, the product is not only non-polluting but can even be used for purification of the environment. As active substance, primarily the following are suitable: iron powder, but also other metals, and/or additional substances that are commonly used in waste water purification, such as activated carbon and zeolites.

Metallic iron is an active substance for binding heavy metals. Other toxins that are dissolved in water can also, however, be separated or destroyed by contact with the iron. In this case, the following reaction mechanisms are used: destruction of toxins by reduction (e.g., chlorinated hydrocarbons, nitrate and chromate), electrochemical separation of toxins by cementation (e.g., copper, mercury), chemical precipitation (e.g., phosphorus), adsorption of Fe oxides or Fe hydroxides (zinc and cadmium). In some toxins (e.g., arsenic, antimony), several of these mechanisms play a role.

The assumption is that heavy metals, which owing to the iron are bonded to the granulate, diffuse through the glass matrix over a relatively long period. Since glass is amorphous, the heavy metals that are adsorbed on the surface can be expected to move deep into the matrix, at least over the long term, because of the different concentration gradients inside and on the surface of the foam glass. Since the diffusion goes in the direction of the lowest concentration, for example, the copper and zinc that are located on the Fe-doped foam glass surface diffuse inside the glass. There, “fresh” metallic iron is present, and the concentration of copper and zinc is at the lowest. Conversely, iron from the glass matrix can be fed to the surface subsequently by solid diffusion.

Owing to its reactive and extremely-small-cell surface, activated carbon is also a known active substance for binding a large variety of toxins and, moreover, is able to bind microbes.

The granulate is also characterized by its production. The granular active substance and the glass fragments are advantageously homogeneously mixed and the mixture is sintered as a layer, which sintered layer is then broken.

As a result, a very simple production is provided. The product that is thus produced has excellent properties relative to compressive strength, angle of repose, permeability of a feedstock, compressibility of a feedstock that consists of a granulate, activity when binding toxins in waste water, etc.

The granulate preferably has cavities in the sintered body. These allow for flow-through of the sintered body or the pellet and/or a low specific weight. In this cavity, penetrating water can come into contact with the grains of active substance that are present there.

The sintered body is advantageously foamed for many applications. It was possible to determine, however, that for waste-water purification, for example, an unfoamed sintered body is just as efficient as a foamed sintered body. It is assumed, because of the surprising positive test results throughout, that the unfoamed sintered body is water-permeable, so that more active substance in the waste-water treatment is involved than only the portion that is visible on the surface of the granulate.

Because of the newly found fact that the washability of antimony and arsenic fixed in the blow-molded glass can be greatly increased during the foaming process of the glass, the object is to provide a bulk material with broken foam: glass lumps that consist of blow-molded glass, in whose eluate only a harmless content of arsenic or antimony is measured, even if the starting substance contains these toxins. In this case, the application-relevant physical and chemical properties of the foam glass and thus bulk material are to remain as unimpaired as possible. The production of this foam glass is to be able to be integrated as much as possible without significant changes into the conventional production process of foam glass fragments.

This object is achieved in that in a bulk material with broken foam glass fragments, the foam glass fragments primarily consist of the contents of conventional foam glasses, namely blow-molded glass and foaming agents, but have a content of metallic iron. The iron particles are present as a variety of inclusions on the surface of the broken-up cells. This metallic iron is embedded in the form of preferably homogeneously distributed, extremely fine inclusions in the foam glass matrix.

The iron content also allows in particular that a foaming agent can be used that acts in a reductive manner during foaming. There are namely assumptions that a reductive action of the foaming agent increases the washability of the toxins.

Surprisingly enough, our tests showed that this foam glass product in the eluate clearly releases less antimony than the zero samples, prepared for comparison, from the same scrap glass powder, but without the addition of iron powder. In addition, it was shown that additional amounts of up to 6% iron to the glass powder mixture—according to corresponding correction of the amount of foaming agents—do not have any significantly disadvantageous effects on the structure and the physical properties of the foam glass (pore size, compressive strength, thermal insulation). The product is black in color, which is without importance, however, for most applications. In a pilot test for the production of 500 m³ foam glass crushed stone, it was verified that the product according to the invention can be produced in a conventional and only slightly modified foam glass production unit.

The product is distinguished by being highly non-polluting. Not only is the antimony fixed, but also other toxins, such as arsenic and chromate, which occur in scrap glass, are effectively bonded. The product can therefore be used in environmentally-sensitive applications, e.g., in the field of hydraulic engineering.

A foam glass fragment with broken-up cells produced from blow-molded glass therefore has a number of inclusions of metallic iron on the surfaces of these cells. As a result, it is prevented that antimony or arsenic fixed in the blow-molded glass, which surprisingly gain an increased mobility by the formation of foam glass, can be washed out from the foam glass.

The inclusions are advantageously fine-grained and homogeneously distributed. It is assumed that the fixing of the toxins is all the better ensured the more homogenous the distribution of the iron is.

The iron inclusions make it possible that the glass starting material of the foam glass can be obtained from scrap glass, since the toxins that occur in scrap glass are fixed by the iron. Thus, foam glass from recycled scrap glass can be used for environmentally-sensitive applications. This allows the advantageous use of the scrap glass that accumulates in gigantic amounts.

If foam glass can also be produced from a foamed glass melt, a foam glass that is produced from a powder mixture by the powder mixture being sintered is preferred. In this case, the powder mixture contains glass powder, a foaming agent that forms gas under the action of heat, and fine-grained, metallic iron powder. The admixture of metallic iron powder is technically easy to carry out in a thus-produced foam glass.

In the foam glass, the metallic iron is advantageous primarily in a grain size of between 1 micrometer and 2000 micrometers, preferably between 10 micrometers and 200 micrometers. The grain size of the iron remains unchanged despite the foam process. To achieve such a foam glass, therefore, a powder mixture, to be foamed by heating, of metallic iron in this grain size is admixed. A mean grain size of the iron of between 20 and 1000 micrometers, advantageously between 20 and 500 micrometers, in particular between 40 and 400 or 50 and 200 micrometers, is especially preferred. Fine-grained iron powder is more expensive than coarse-grained iron powder, but a clearly better action in the fixing of toxins in foam glass develops. A preferred embodiment of the process therefore calls for grinding coarse-grained iron powder together with the rough glass, by which extremely fine iron dust is produced, which, moreover, is dispersed very homogeneously in the glass powder. As iron powder, e.g., fine-grained spray dust can also be used. The iron that is contained in the scrap glass, e.g., bottle caps, which were previously sorted out and added to old iron, can advantageously be directly reused in pulverized form in the foam glass.

A content of fine-grained, metallic iron in the foam glass advantageously lies between 0.5 and 8% by weight, preferably between 1 and 4% by weight. In these areas, the addition of foaming agent is adjustable, and the product exhibits only a few other application-relevant properties, such as compressive strength, closed cells, cell size, cell density, bulk density, insulating values, etc. In particular, the more limited range has proven especially suitable to adequately eliminate the washability of the toxins without impairing the other properties of the foam glass. As the foam glass of conventional quality, the foam glass element therefore suitably has a bulk density of between 200 and 800 kg/m3, preferably between 300 and 500 kg/m3. A target cell density lies between 300,000 to 2,000,000 cells per cm3, and preferably of more than 600,000 pores per cm3. Also, the cells advantageously are isolated from one another with the product according to the invention. A target compressive strength is certainly more than 1 N/mm2, preferably more than 4 N/mm2, and especially preferably more than 6 N/mm2. Compressive strengths of more than 6 N/mm2 allow the use of foam glass in a load-bearing range.

The glass powder and the foaming agent suitably are present in a weight ratio of between 85:15 and 98:2.

The foam glass is present in fragments with broken-up cells. Such foam glass lumps are very commonly used in particular as an inorganically- or organically-bonded construction material or as a bulk material, for example in highway engineering, drainage, perimeter insulation or in earth retaining walls.

Metallic iron is present in this broken foam glass granulate on the surfaces with broken-up cells.

The broken foam glass granulate suitably has a grain size of between dust and 64 mm. Loose or bonded feedstocks from a foam glass of an individual grain size or a few grain sizes are suitable for permeable volumes. The grain size can be selected corresponding to the application. For applications in concrete or other bonded elements, the granulate has a preferably balanced grading curve with various grain sizes of between dust and 64 mm. In this case, not all grain sizes need exist. Supplementing with other additives is possible, whereby the grading curve of all additives advantageously produces a Fuller curve.

The invention also relates to a powder mixture for the production of environmentally compatible foam glass, which has a powder mixture in addition to the primary component of glass powder from blow-molded glass, in particular scrap glass powder, and a foaming agent according to the invention that forms gas under heat action, and also metallic iron powder. In this case, this powder mixture is essentially free of sodium hydroxide.

The powder mixture advantageously has a content of metallic iron of between 0.5 and 8% by weight, preferably between 1 and 4% by weight. The glass powder and the foaming agent suitably are present in a ratio by weight of between 85:15 and 98:2.

The invention also relates to a process for the production of foam glass, in which glass powder that consists of blow-molded glass, especially scrap glass, and a fine-grained foaming agent that forms gas under the action of heat, are mixed homogeneously with one another. The thus resulting powder mixture is—as in the conventional foam glass production, applied in one layer on a base, and this layer is heated in a furnace. The thus sintered and foamed glass is then cooled and broken into foam glass fragments. According to the invention, the process is distinguished from conventional processes in that in the production of the powder mixture, additional iron powder is homogeneously mixed with the glass powder and the foaming agent. This allows in particular the foam glass production under reductive or strongly reductive conditions. The addition of water is avoided. The powder mixture is therefore preferably mixed dry and applied in an unwetted state to the base and foamed as a loose feedstock.

The breaking of the foam glass is carried out in a first step based on the stress cracking in the cooling foam glass. The foam glass fragments that result therefrom are easy to stack, to transport and can be used partially in unchanged form. They can also further be broken mechanically, however, then, for example, graded, and individual grain sizes can be mixed together again in a specific mixing ratio.

The advantage of the bulk material according to the invention is that its use in environmentally-sensitive areas is harmless. This harmlessness is itself provided if the glass starting substance that is used is scrap glass or for other reasons contains more than 1 mg/kg or even more than 5 mg/kg of antimony and/or arsenic. This has the advantage that the starting product does not need to be examined for its ability to contain toxins. Also, no identification and no sorting-out of toxin-containing scrap glass is necessary.

The invention also relates to the use of the bulk material according to the invention as an additive for the production of an inorganically- or organically-bonded construction material or as loose bulk material. These uses are also possible in an environmentally-sensitive area, especially in contact with ground water, surface water or drinking water, e.g., in hydraulic engineering, in underground structures or in building construction.

Another object consists in providing a bulk material for water purification, which, can be used, i.a., instead of sand in sand filters in sewage treatment plants. The bulk material for water purification is to filter out solids found in water and can bind toxins dissolved in water, e.g., phosphates and heavy metals. The bulk material for water purification should be economical on an industrial scale and preferably can be produced, in some cases, from recycled wastes.

This object is achieved by a bulk material for water purification, which consists of a broken granulate of a sintered body produced from crushed blow-molded glass, in particular from a broken granulate of a foam glass, or has such a granulate. This granulate is distinguished by an active substance that is present in the broken surface and embedded as grain in the glass matrix. The active substance is such a substance that interacts with selected toxins contained in particular in water. This interaction is in general an adsorption or a chemical reaction.

The granulate is produced by breaking a foamed or unfoamed sintered body. By the breaking, the active-substance grains embedded inside the element in the glass matrix penetrate the broken surface. In the case of unfoamed sintered bodies, it is assumed, based on the surprising results, that the active substance that is present inside the granulate also has influence on the purification action of the granulate.

Separation of the bulk material for the water purification and the active substance is not possible, since the active substance is fixed in the granulate. As a result, a homogeneous feedstock is produced. Owing to the incorporation of the active substance in a granulate of a considerably larger grain size than the grain size of the active substance, a formation of sludge is also prevented.

This granulate can be produced in widely simplified variants. A broad range of possible uses is produced by selection of the type and number of active substances, the grain size, the pore size and the specific weight (in particular in the case of foam glass).

As active substance, primarily the following are suitable: iron powder, but also other metals, and/or other substances that are commonly used in waste-water purification, such as activated carbon and zeolite.

The proportion of metallic iron advantageously lies between 2 and 4% granulates for construction purposes. In granulates for waste-water purification, the proportion of iron advantageously lies between 4 and 20%, especially preferably between 6 and 10%. Proportions of iron of up to 50% are conceivable. In initial tests, however, no improvement of the purification action could be determined when the proportion of iron was raised above 8%. It cannot be ruled out, however, that the proportion of iron in the long-term action of the granulate has a significant influence.

Owing to their reactive and extremely-small-cell surface, activated carbon is also a known active substance for binding a large variety of toxins and is able, moreover, to bind microbes.

Selected zeolites are excellently suited for use as active substance that is embedded in the sintered glass element. These zeolites are activated namely only by high temperatures, as they are necessary for sintering. During sintering of the glass or foaming of the foam glass, the latter are therefore activated simultaneously. Sparingly soluble alkaline-earth fluorides advantageously can be added to the glass powder, and said fluorides are reacted during sintering to form the desired readily soluble alkali fluorides.

In the glass matrix, aluminum powder and/or magnesium powder can also be present. With these metals, electrochemical local elements are formed, owing to which the iron dissolves with the formation of rust.

It is surprising that even closed-cell foam glass is an ideal carrier for active substances. Against expectations, closed-cell foam glass forms an ideal starting product for the production of a bulk material for water purification. The foam glass granulate is produced by breaking a foam glass layer or already broken foam glass lumps of the open-cell or closed-cell foam glass. The grain size can therefore be refined by breaking as desired. In this broken granulate, the active substance is distributed uniformly. The specific weight of the granulate can be set by specific control of the production process. Closed-cell foam glass can be produced on an industrial scale with very fine pore walls and with, nevertheless, a high compressive strength in a uniform quality. The surfaces of such broken pellets consist of the concave pore surfaces of the broken-up pores. The effective surface area of such pellets is therefore very large. Active substances that are embedded in the walls or the pore surfaces are protected from abrasion in these concave recesses. The exchange between the active granulate surface and the water to be purified at the same filter volume and the same grain size is very large in comparison to spherical granulate that is granulated before sintering. The effective surface areas of the granulate are large and are easily accessible for water.

A closed-cell foam glass is advantageously produced by heating a dry powder mixture that contains at least glass powder, the granular active substance, and a foaming agent that forms gas under the action of heating. Therefore, the active substance is embedded as a grain in the pore wall. The active substance is thus bonded in the glass matrix and mechanically held in the pellet. As glass powder, those from recycled glass wastes can be used.

Owing to the large pore surfaces of the broken-up pores, in whose walls the active substance is bonded, the pore spaces cannot increase on or around the active grain even when deposits form.

Advantageously, the foaming agent foams under reductive conditions. The reductive conditions that are prepared by, e.g., SiC promote the integration of activated carbon in the glass matrix.

Closed-cell foam glass generally has a primary volume of relatively large cells, which are also called macropores. The walls between these macropores are also penetrated by smaller pores, which also are called micropores. The foam glass granulate of the bulk material advantageously has a maximum pore size of the foam glass that corresponds at least to the grain size of the foam glass granulate. This has the effect that virtually all macropores are broken up and thus as large a surface of the granulate as possible can be effective. If virtually all macropores are broken up, virtually all grains of the active substance also lie on the effective surface area of the granulate and can make contact with the water to be purified. A preferred grain size of the granulate lies between 1 and 6 mm, advantageously between 2 and 5 mm, and especially preferably between 3 and 4 mm.

The pellets that are obtained by such extensive breaking have a surface that consists of partial areas of the pore surfaces of a number (e.g., 4 to 8) of macropores. In a feedstock, the pellets with projecting wall parts engage in the concave recesses of an adjacent pellet. This produces good micro-eddying of water flowing through the packing. The water is therefore in intensive exchange with the very large surface areas of the broken-up pores.

The foam glass granulate for the bulk material can advantageously have a water-soluble additive in the form of grains embedded in the foam glass. Such water-soluble additives are formed by, for example, a halogen compound, an oxide, hydroxide, sulfate, carbonate or a phosphate of sodium, potassium, calcium, magnesium or iron.

The addition of a water-soluble grain allows the granulate to break into a grain size that has a larger diameter than the diameter of the macropores, without the pore surfaces of the pores that are not broken up thus being robbed of their effectiveness. The water-soluble additives dissolve namely during the use of the bulk material. As a result, little by little additional pore surfaces of macropores and micropores become active. Therefore, in such a bulk material for water purification, new, fresh active substances constantly become available. In the case of skillful selection on their part, the additives can have a positive effect on the waste water, e.g., by pH buffering, by continuous release of flocculating agents or oxidizing agents, nutrients and the like.

Such a foam glass is suitably produced from a mixture that contains at least glass powder, the granular active substance, a foaming agent that forms gas under the action of heat, and a granular water-soluble salt. This mixture is also propagated without adding liquid to a base as a powder layer and is foamed by heating.

“Water-soluble” salts are in particular the not very soluble salts that are referred to in English language use as “semi-soluble.” As such water-soluble salts, in particular the following are suitable: gypsum, lime, and/or pH-modifying substances such as magnesium oxide. Magnesium oxide has the advantages of being non-polluting, buffering aqueous solutions at a pH of about 10.5 and thus fixing virtually all heavy metals as hydroxides.

If the foam glass is to be etched in a very porous element, alkali fluorides can also be sintered in the glass matrix, and the foam glass granulate then can be treated with water. The fluorides together with water form hydrofluoric acid that corrodes the glass. For environmental reasons, of course, such a treatment cannot be performed by use in the water to be purified. In the case of foam glass production, sparingly soluble alkaline-earth fluorides can advantageously be added that are reacted during the burning process to form the desired readily soluble alkali fluorides.

In the glass matrix, aluminum powder and/or magnesium powder can also be present. With these metals, electrochemical local elements are formed, owing to which the iron is dissolved with the formation of rust.

The specific weight of the bulk material that is filled with water is advantageously set to 1000±200 kg/m3. This produces a floating or quasi-floating bulk material for water purification. Such a one can be easily back-flushed. The weight of the foam glass or the lifting force of the foam glass granulate can be set by the pore volume of the pores that are not broken up. These are primarily the micropores in the pore walls of the macropores. In contrast, the weight can be set by the proportion of active substances. It has been shown, for example, that in a suitable foaming agent addition, 80% of the foam glass pellets with an iron content of up to 2% floats in water, while with an iron content of 8% or more, 80% of the pellets sink in water.

If (micro- or macro-) pores that can decompose in foam glass by dissolution of water-soluble additives are present, advantageously the specific weight of the water-filled bulk material can be set at about 1000 kg/m3 before the dissolution of the water-soluble salts and at more than 1000 kg/m3 after dissolution of the water-soluble salts. This produces an automatic separation of the consumed bulk material from fresh bulk material under the action of gravity or the floating height of the granulate in the water that is to be purified.

For a bulk material for water purification, which floats in water, an iron portion of 3 to 6% by weight of the dry weight in the granulate is suitable.

In the case of an iron portion of more than 6% by weight of the dry weight, an optimal pore size of about 3 mm is produced. In addition, the granulate can be influenced magnetically. In this respect, this can be used to separate fine portions of the foam glass from a suspension with other dirt substances using a magnet. This advantage can also then be used if iron contained in the foam glass is not used for treatment of toxins of water.

Sintered glass granulate that is doped with iron or foam glass granulate is also suitable for removing extremely small paramagnetic particles from aqueous suspensions. In this respect, fields of applications exist, for example, in the renovation of iron ores, but also in the area of waste water (steel mills, etc.) and in the separation of extremely small iron oxide-containing sludges. Such sludges accumulate when iron powder was dispersed in the waste water for the purpose of adsorption of toxins. To then remove this sludge again (advantageously without flocculant or an expensive mechanical filtration) from the waste water stream, a magnetic separation into a filter feedstock with the iron-doped bulk material is suggested. To bring the magnetic field as “near” as possible to the suspension, the feedstock that can be magnetized and through which the suspension flows is arranged between magnetic poles. The paramagnetic particles that are present in the suspension are then magnetically bonded to the iron particles (e.g., steel chips) that are present in the granulate. Periodically, the magnetic field is turned off, and the material that is deposited on the magnetized iron particles that are embedded in the glass matrix are flushed out. To create high magnetic field gradients, “pointed” surfaces or edges on the iron portions of the feedstock are preferred. In a preferred embodiment of the invention, therefore, the embedding of magnetizable but stainless iron chips (e.g., 0.5-5 mm) in the granulate exists. In this case, in addition to the magnetizability, the bulk material according to the invention has the advantages of a very good ability to percolate and a large active surface area.

The bulk material for water purification according to the invention can also be dispersed as a fine-grained powder in the waste water stream and if it contains iron, then it can be removed from the latter by means of magnets.

The bulk material for water purification according to the invention can be used for waste water purification in a multi-stage sewage treatment plant, in particular in the last stage. In modern plants, this stage consists of a sand filter that periodically reverses its flow or is continuously regenerated in a circuit. The bulk material for water purification according to the invention replaces this pure mechanical filter medium as an active filter medium. Owing to its iron portion, it binds still present phosphate radicals and heavy metals. The large surface area, the high mechanical strength and the low specific weight impart to the bulk material (foam glass or unfoamed sintered glass) a specific suitability for use in such a filter stage. A portion of the bulk material for the water purification can be drawn off continuously and can be replaced by fresh or regenerated bulk material. The bulk material that is drawn off is regenerated chemically or preferably thermally.

The bulk material for water purification according to the invention can also be used in drinking water renovation to bind toxins such as arsenic, antimony, mercury, salts, chromate, phosphate, nitrate, and organochlorine compounds (such as CKW, pesticides). Owing to the presence of Fe⁰, some endocrine toxins and organic complexing agents are bonded with such a filter or destroyed.

The bulk material for water purification can also be used for storm-water renovation. In this case, for example, the thought here is the renovation of storm water that runs off metal-covered roofs. In particular, copper, lead, tin, and zinc can be precipitated from the latter before it seeps or is sent to a sewer system.

Fe⁰ can also be used for binding or destroying endocrine toxins, regardless of the binding of the iron into a carrier.

### SHORT DESCRIPTION OF THE FIGURES

FIG. 1 shows a diagram with substance concentrations in an acid eluate according to measured values of four samples.

FIG. 2 shows an enlargement of a section through a closed-cell foam glass with an iron particle embedded therein.

FIG. 3 shows a table with the plot of the toxin concentration in an overhead eluate according to the Swiss “Technische Verordnung über Abfälle” (TVA), Appendix 1.

FIG. 4 shows a diagrammatic visualization of two pellets with inner surfaces of broken-up macropores on their surfaces.

FIG. 5 shows diagrammatically a cutaway of a ground face of a sintered pellet according to the invention that is not foamed and consists of glass powder and active grains.

FIG. 6 shows a diagram of the development of the copper concentration in a solution whereby plots are compared between the use of expanded glass and the use of pellets that are only sintered according to the invention.

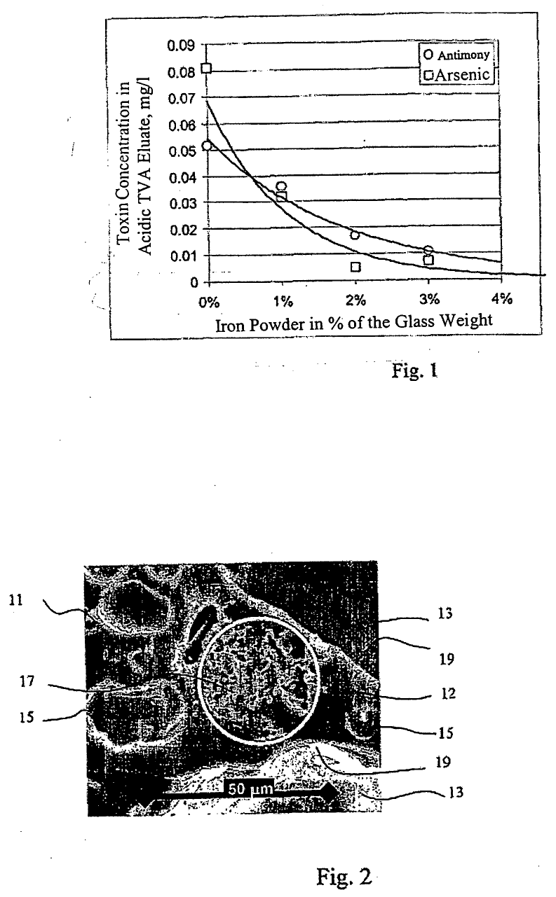

FIG. 1 shows a diagram whose y-axis contains values for the substance concentration in an acid eluate according to the Swiss “Technische Verordnung über Schadstoffe in Milligram Schadstoff pro Liter Eluat [Technical Ordinance on Toxins in Milligram of Toxin per Liter of Eluate]. On the x-axis, percentages for the proportion by weight of metallic iron in a sample is indicated. The diagram shows the measured values of four samples: the measured values of a zero sample, which is a foam glass without the addition of iron, a first sample with an iron proportion of (1%) percent by weight, a second sample with an iron proportion of (2%) percent by weight, and a third sample with an iron proportion of (3%) percent by weight. The measured values for antimony are approximately 0.052 mg/l in the zero sample, 0.037 mg/l in the first sample, 0.018 mg/l in the second sample, and 0.011 mg/l in the third sample. The measured values for arsenic are approximately 0.081 mg/l in the zero sample, 0.032 mg/l in the first sample, 0.005 mg/l in the second sample, and 0.008 mg/l in the third sample.

By the addition of 2 to 3% by weight of iron powder in the powder mixture for the production of a foam glass element, the inert substance boundary value for arsenic (0.01 mg/l) can therefore be maintained.

A test that leads to the cited results is performed as follows.

As a raw material for all four samples, a mixture that consists of 98% scrap glass powder and 2% foaming agent from the production of foam glass production is used. The available starting material of the foam glass production of the applicant is used. The scrap-glass powder of the sample contains 10 mg/kg of antimony and 11 mg/kg of arsenic, which are fixed in the glass. In each case, a sample of 200 g of this mixture is mixed into 1%, 2% or 3% iron powder of technical quality (i.e., 2 g, 4 g and 6 g). The metallic iron powder has an average grain size of below 100 micrometers. The three samples from powder mixtures according to the invention are reboiled in a muffle furnace and, after cooling, produce foamed glass elements according to the invention. These foam glass elements are granulated to a grain size of 2 to 6 mm. An analogous process parallel to this is carried out with a zero sample without an iron addition. In each case, 100 g of these granulates of the zero sample and the three samples according to the invention are shaken for 24 hours overhead in 11 of water (“acidic eluate” according to Swiss TVA). Then, the antimony concentrations and the arsenic concentrations in the four eluates are measured.

The results are depicted in FIG. 1. The product according to the invention with 3% iron has an antimony concentration in the eluate that is reduced by 80% relative to the zero sample. The arsenic concentration was even reduced by 90%.

Foam glass element 21 that is depicted in FIG. 2 is from a foam glass 11 that was obtained by heating a powder mixture to about 700 to 900 degrees. At these temperatures, the mineral foaming agent forms gas that remains trapped in the glass, liquefied in the meantime, in the form of bubbles 13, 15. The bubble size corresponds to the amount of gas that was determined at the same spot, whereby in the case of larger layer thicknesses, the prevailing pressure conditions cause lower bubbles to be somewhat smaller on average than upper bubbles. The foamed glass hardens by cooling, whereby the bubbles remain as hermetically sealed cells in a pressure-resistant foam element.

Macropores whose diameters measure, for example, between 1/10 to 5 mm are referred to with 13. These macropores form the main volume of foam glass element 21. Walls 12 that consist of foam glass 11 are present between the macropores. These walls 12 contain micropores on the order of magnitude of the ten-micron range. Active substances that are enclosed in the foam glass during the sintering of the foam glass are also embedded in these walls 12. In the example of FIG. 2, set off by a white cross, an iron particle 17 can be seen. The latter is very fine-grained (about 30 μm). It is trapped in a foam glass pellet 21, whose grain diameter is about 3 mm. The grain has a specific weight of 1100 kg/m3. This weight is produced owing to the high specific weight of the iron, on the one hand, and the lifting force through the micropores, on the other hand. The specific weight of the grain can be controlled by setting the number of micropores and the iron portion in the foam glass.

Iron particle 17 adjoins the interior space in the two depicted macropores. Water, which flows along pore surface 19 of the macropores, comes into contact with the iron. Toxins that are present in the water are bonded in this contact or destroyed. Some possible mechanisms of action are described above.

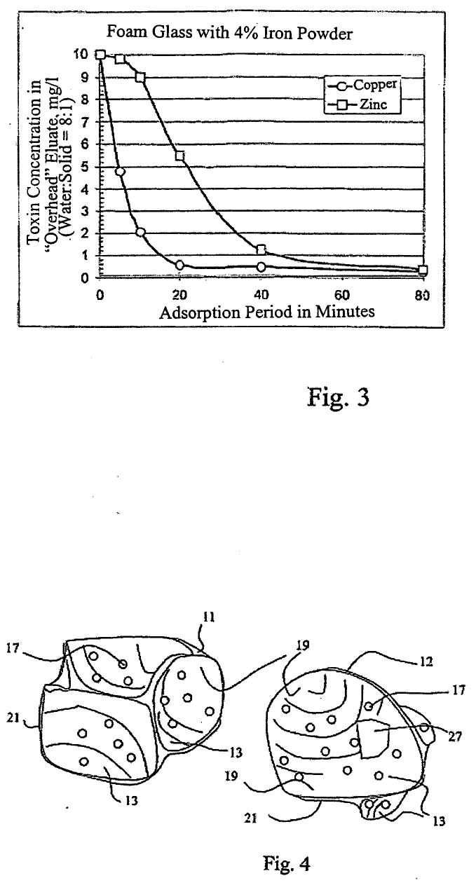

FIG. 3 shows the results of two test series for removing copper or zinc from greatly diluted aqueous solutions. A foam glass that is doped with 4% iron powder is introduced. 20 g of this foam glass is granulated to a grain size of 6 mm and shaken “overhead” with 160 ml of heavy metal solution. The heavy-metal-containing solutions in each case contain 10 mg/l of copper and 10 mg/l of zinc. Periodically, samples are drawn off from the solution and analyzed with the heavy metal content. It can be seen clearly in FIG. 3 how the heavy metal content in the solution is very greatly reduced within a short time. After less than one hour of treatment period, the purified solutions already have the quality of drinking water.

Foam glass granulate 21, depicted diagrammatically in FIG. 4, is broken into smaller pieces than the diameter of an average macropore. Therefore, in the granulate, only the micropores are not broken up. As a result, the surface area of the grain is very large. Accordingly, it has a low, specific weight. On the surfaces, iron grains 17 (depicted as crosses) are distributed. Owing to the intervals between the iron grains from one another, there is no danger that in shaking, the continuous-flow openings for the water were clogged because of deposits on the iron parts. This ensures a virtually uniform activity of the bulk material over the entire service life.

In one grain, moreover, an inclusion of a water-soluble grain 27 is depicted. In the grain shown, there is no need to open up a pore that is still not broken up. Accordingly, a water-soluble grain is enclosed in the glass matrix of the wall. The water-soluble grain is magnesium oxide, and it has a water-purifying action. Inclusions that consist of activated carbon or water-soluble salts, which, for the purpose of a delayed inclusion of closed cells, where added to the powder mixture that consists of glass powder and foaming agent, look similarly. Similarly, inclusions that consist of activated carbon or water-soluble salts are also seen, which can be added to the delayed inclusion of closed cells of the powder mixture that consists of glass powder and foaming agent.

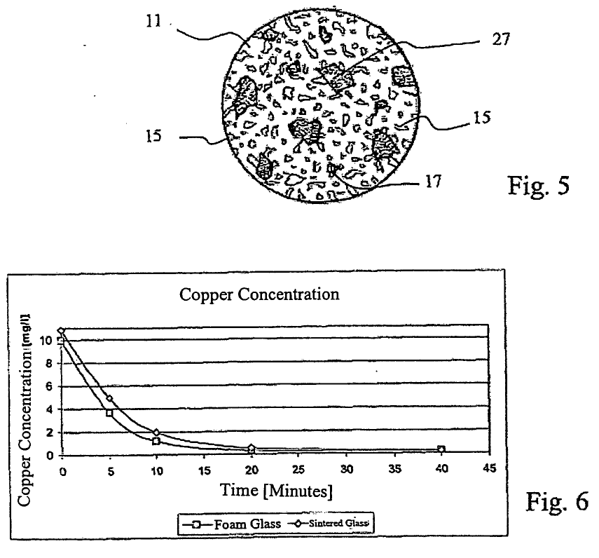

The visualization according to FIG. 5 is based partially on the assumption that when glass powder is sintered without an expansion element, the glass particles cannot melt to form a cavity-free mass. It is suggested that between the weighted or liquid glass particles, air inclusions are present that are to remain even after the solidification of sintered body 21′. The depicted air inclusions are definitively depicted too large. The size and the number of air inclusions can be influenced depending on the sintering temperature and the grain size of the broken blow-molded glass. For sintered glass, advantageously a larger grain with the starting product is used as a foam glass. It can be gathered from FIG. 5 that the unexpanded sintered body 21′ is run through homogeneously with grains and an active substance 17 and possibly is penetrated by cavities 15′. In contrast to cavities 15 in foam glass element 21, cavities 15′ are not spherical and are significantly smaller. It is expected that the cavities form a readily penetrable labyrinth through which water can flow or that can be readily penetrated by toxins or active substances. In any case, surprisingly enough, the test results with unfoamed sintered bodies according to the invention are good, which is expected, such that an essentially larger surface area of the active substance iron in the purification of waste water is effective as the one just visible on the surface of the granulate.

In the diagrams according to FIGS. 6 and 7, the results from comparison examples for water decontamination are depicted. The results from a test with an expanded granulate according to the invention are compared to the results from a second test with the granulate that is just sintered according to the invention.

As a starting material for the production of the foamed granulate, ground glass of the Misapor Company (grain size<0.2 mm) is used. The ground glass of Misapor is mixed with 2% SiC and 8% iron powder (manufacturer: Rocholl) in a ball mill and then foamed in an earthenware pot in a muffle furnace.

Scrap glass (grain size 0.355-0.5 mm) that is ground in the jaw crusher is used as a starting material for the granulate that is just sintered. The glass that is crushed in the jaw crusher is also mixed manually with 8% of the same iron powder (manufacturer: Rocholl) and 21 ml of demineralized water and then sintered in an earthenware pot in a muffle furnace.

Grain sizes of starting products, portions of foaming agents, metallic iron and water in the mixture, test amounts, grain size of the granulate and the temperature and the dwell time of the two sinterings can be found in the following table.

| | Foam Glass | Sintered Glass |
|---|---|---|
| Grain Size of the Broken | <0.2 mm | 0.355-0.5 mm |
| Blow-Molded Glass | (Misapor AG) | (Crusher) |
| Proportion of SiC in the | 2% | — |
| Mixture | | |
| Proportion of Fe in the | 8% | 24% |
| Mixture | | |
| Grain Size of the Fe | Ø˜0.06 mm | Ø˜0.06 mm |
| | (Rocholl) | (Rocholl) |
| Amount of Water for Mixing | — | 21 ml |
| Type of Mixing | Ball Mill | Wet, Manual |
| Amount per Earthenware Pot | 100 g | 100 g |
| Dwell Time in the Furnace | 17 Minutes | 25 Minutes |
| Temperature in the Furnace | 950° C. | 800° C. |
| Granulate Size After the | 0.5-2 mm | 0.5-2 mm |
| Sintered Body is Crushed | | |
| Magnetism | Very Strong | Very Strong - |

The copper solution that is used has the following properties: Cu(NO₃)₂ in HNO₃ of the concentration 1000 mg/1 Cu (Merck standard solution) diluted with demineralized water to a concentration of 10 mg/1 Cu. In this case, a pH of the copper solution of ˜2.5 is produced.

In the two tests, the procedure is as follows:

15 g of the respective granulate is added together with 120 ml of the above-mentioned copper solution in a container. The container is clamped into an overhead shaker. The overhead shaker is allowed to run at an rpm of 16 u/minute. After 5, 10, 20 and 40 minutes, in each case samples with 10 ml of solution are removed from the container. The overhead shaker is briefly halted for this purpose.

In the solution that is removed in each case, the pH is measured.

The solution is then acidified with 1 ml of 1 molar HNO₃ solution and allowed to stand for 10 minutes. During these 10 minutes, the solution is shaken intermittently. Now, the solution is filtered (filter paper: Schliecher & Schüll) and finally analyzed in an atom absorption analysis spectrometer. In this case, copper concentrations that are depicted in FIG. 6 are measured in the samples removed after 5, 10, 20 and 40 minutes.

It was determined, surprisingly enough, that the foamed glass and the sintered glass are almost equally well cut. Only small differences in kinetics can be discerned.

Closed-cell or open-cell foam glass and unfoamed sintered glass are used according to the invention, thus can be combined as a carrier for an active substance enclosed therein, such as, e.g., iron dust, iron chips, activated carbon or magnesium oxide, and are broken into a granulate. The granulate that consists of closed-cell foam glass is pressure-resistant, light, and has a large, quickly effective surface area from concave pore surfaces of broken-up pores. The pore size and the specific weight of the granulate can be adjusted in production. A granulate that consists of unfoamed sintered glass has a high compressive strength and a higher specific weight. Despite smaller macroscopically visible surfaces, it is just as effective as a foam glass granulate. The production of the granulate can be performed on an industrial scale and in an economical manner from recycled glass wastes. The granulate can be used as a bulk material for water purification.

The uses are, for example, drinking water renovation from ground water, contaminated spring water or from surface water, waste-water treatment, especially as a last stage with filter properties and for binding heavy metals and phosphates. In addition, it can be used for purification of water that consists of precipitation, in particular roof or street runoff. The granulate can be regenerated chemically and thermally. The regenerated product can be expanded to form new foam glass or sintered to form unexpanded sintered glass and then as a construction material, such as concrete additive or perimeter insulation, or again as a bulk material, for water purification.

1. Granulate comprising:
fragments of a sintered body that is sintered from a crushed blow-molded glass, with a number of inclusions of at least one active substance on broken surfaces of granulate, which active substance is embedded as a grain in the sintered body and can interact with toxins upon contact with the toxins.

2. Method of producing a granulate comprising fragments of sintered body that is sintered from a crushed blow-molded glass, with a number of inclusions of at least one active substance on the broken surfaces of granulate, which active substance is embedded as a grain in the sintered body and can interact with toxins upon contact with the toxins, the method comprising:
mixing a granular active substance with the crushed blow-molded glass, and
sintering one layer of this mixture and then breaking the sintered layer.

3. Granulate according to claim 1, wherein the active substance is present primarily in a grain size of between 1 micrometer and 2000 micrometers, preferably between 10 micrometers and 200 micrometers.

4. Granulate according to claim 1, wherein the active substance iron is in metallic form.

5. Granulate according to claim 4, comprising: iron as an active substance and an average grain size of the iron of between 20 and 1000 micrometers, preferably between 20 and 500 micrometers, especially preferably between 40 and 400 micrometers, in particular between 50 and 200 micrometers.

6. Granulate according to claim 5, comprising a content of fine-grained, metallic iron of between 0.5 and 8% by weight, preferably between 1 and 4% by weight.

7. Granulate according to claim 6, wherein the inclusions are fine-grained and are distributed homogeneously.

8. Granulate according to claim 1, wherein sintered body has cavities.

9. Granulate according to claim 1, wherein the glass is obtained from glass wastes.

10. Granulate according to claim 1, wherein the sintered body is foamed.

11. Granulate according to claim 10, wherein the foaming is achieved with a foaming agent that has a reductive effect during foaming.

12. Granulate according to claim 11, wherein granulate that consists of foam glass is broken, and its outer surface is formed essentially by foam glass pores that are broken up by several concave partial areas of pore surfaces.

13. Granulate according to claim 12, wherein foam glass has macropores and micropores in walls between macropores, and granulate has closed micropores.

14. Granulate according to claim 13, wherein granulate that consists of closed-cell foam glass is broken.

15. Granulate according to claim 1, comprising a maximum pore size of foam glass that corresponds to at least the grain size of foam glass granulate.

16. Granulate according to claim 15, wherein a compressive strength of the foam glass fragments of more than 2 N/mm2, preferably of more than 4 N/mm2, especially preferably of more than 6 N/mm2.

17. Granulate according to claim 15, comprising a water-soluble additive as an active substance in the form of grains embedded in foam glass.

18. Granulate according to claim 17, wherein magnesium oxide or magnesium hydroxide is embedded as a water-soluble additive in the glass matrix of foam glass.

19. Granulate according to claim 1, wherein iron particles are present as chips in the granulate.

20. Granulate according to claim 19, wherein iron particles that consist of stainless steel are present.

21. Granulate according to claim 1, wherein grains of activated carbon are present as active substances.

22. Granulate according to claim 1, wherein grains of zeolites are present as active substances.

23. Granulate according to claim 1, wherein in addition, one or more of the following substances are present in the granulate: aluminum powder, magnesium powder.

24. Granulate according to claim 1, wherein a halogen compound, an oxide, hydroxide, sulfate, carbonate or a phosphate is present as an active substance, especially such a one of sodium, potassium, calcium, magnesium, or iron.

25. Granulate according to claim 1, comprising a specific weight of water-filled granulate of 1000±200 kg/m3.

26. Granulate according to claim 1, comprising a metallic iron portion of more than 6% by weight of dry weight, preferably between 6 and 20, and especially preferably between 7 and 10% by weight.

27. Granulate according to claim 10, wherein the foam glass that consists of a powder mixture is sintered, which powder mixture contains glass powder, a foaming agent that forms gas under the action of heat, and a fine-grained active substance, in particular metallic iron powder.

28. Granulate according to claim 1, comprising a common grain size of all fragments between dust and 64 mm, preferably between 1 and 32 mm.

29. Granulate according to claim 28, comprising a grain size of between 2 and 8 mm, preferably between 2 and 4 mm.

30. Bulk material with a granulate according to claim 1, having a grading curve, in particular a Fuller grading curve with the grain sizes of between dust and 64 mm, preferably between 1 mm and 32 mm.

31. Process for the production of a sintered glass granulate, the process comprising:
producing a glass powder from blow-molded glass or glass waste;
mixing the glass powder and a granular active substance with one another;
heating a resulting powder mixture in a furnace to produce a sintered glass;
cooling the sintered glass; and
breaking the sintered glass into fragments, wherein upon temporary heating to about 900 degrees, the active substance used in the mixture becomes capable of interacting with toxins upon contact with the toxins that may be suspended or dissolved in water.

32. Process according to claim 31, wherein the glass powder and the active substance are mixed with water, and the moist mixture is sintered.

33. Process according to claim 31 for the production of foam glass, in which the glass powder and a fine-grained foaming agent that forms gas under the action of heat and the granular active substance are homogeneously mixed with one another, and the mixture is foamed in a furnace.

34. Process according to claim 31, wherein the active substance is an iron powder whose average grain size is preferably between 20 and 1000 micrometers, especially preferably between 20 and 500 micrometers, quite especially preferably between 40 and 400 micrometers, or else between 50 and 200 micrometers.

35. Process according to claim 34, wherein the foam glass production is carried out under reductive conditions.

36. Method for producing an inorganically- or organically-bonded construction material, the method comprising:
producing a foamed granulate having fragments of a sintered body that is sintered from a crushed blow-molded glass, with a number of inclusions of at least one active substance on the broken surfaces of granulate, which active substance is embedded as a grain in the sintered body and is capable of interacting with toxins upon contact with the toxins, and
adding the granulate to an inorganically or organically bonded construction material.

37. Method for producing an inorganically- or organically-bonded construction material, the method comprising:
producing a granulate having fragments of a sintered body that is sintered from a crushed blow-molded glass, with a number of inclusions of at least one active substance on the broken surfaces of granulate, which active substance is embedded as a grain in the sintered body and is capable of interacting with toxins upon contact with the toxins, and
adding the granulate to an inorganically or organically bonded construction material.

38. Method for producing loose feedstock, the method comprising:
producing a granulate having fragments of a sintered body that is sintered from a crushed blow-molded glass, with a number of inclusions of a least one active substance on the broken surfaces of granulate, which active substance is embedded as a grain in the sintered body and is capable of interacting with toxins upon contact with the toxins,
producing loose feedstock from the granulate, wherein the sintered body is foamed.

39. Method for treating an environmentally-sensitive area, the method comprising:
producing a foamed granulate having fragments of a sintered body that is sintered from a crushed blow-molded glass, with a number of inclusions of at least one active substance on the broken surfaces of granulate, which active substance is embedded as a grain in the sintered body and is capable of interacting with toxins upon contact with the toxins; and
applying the granulate to the environmentally sensitive area.

40. Method for treating an environmentally-sensitive area, the method comprising:
producing a foamed granulate having fragments of a sintered body that is sintered from a crushed blow-molded glass, with a number of inclusions of at least one active substance on the broken surfaces of granulate, which active substance is embedded as a grain in the sintered body and is capable of interacting with toxins upon contact with the toxins; and
applying the granulate to the environmentally sensitive area.

41. Method for purifying waste water in a multi-stage industrial or municipal sewage treatment plant, the method comprising:
producing a granulate having fragments of a sintered body that is sintered from a crushed blow-molded glass, with a number of inclusions of at least one active substance on the broken surfaces of granulate, which active substance is embedded as a grain in the sintered body and is capable of interacting with toxins upon contact with the toxins; and
purifying waste water with the granulate.

42. Method to filter out floating particles and/or to bind dissolved toxins comprising:
producing a granulate having fragments of a sintered body that is sintered from a crushed blow-molded glass, with a number of inclusions of at least one active substance on the broken surfaces of granulate, which active substance is embedded as a grain in the sintered body and is capable of interacting with toxins upon contact with the toxins; and
filtering floating particles and/or binding dissolved toxins with the granulate.

43. Method for renovating drinking water, storm water or for preparing street waste water comprising:
producing a granulate having fragments of a sintered body that is sintered from a crushed blow-molded glass, with a number of inclusions of at least one active substance on the broken surfaces of granulate, which active substance is embedded as a grain in the sintered body and is capable of interacting with toxins upon contact with the toxins; and
renovating drinking water or storm water, or preparing street waste water with the granulate.

44. Method for destroying or binding endocrine toxins in water comprising:
producing a granulate having fragments of a sintered body that is sintered from a crushed blow-molded glass, with a number of inclusions of at least one active substance on the broken surfaces of granulate, which active substance is embedded as a grain in the sintered body and is capable of interacting with toxins can interact with the sintered body upon contact with the toxins; and
destroying or binding endocrine toxins in water with the granulate.

45. Granulate according to claim 1, wherein the active substance is capable of interacting with toxins which are suspended or dissolved in water.

46. Use of the granulate according to claim 1 for perimeter insulation.

47. Use of the granulate according to claim 1 for drainage.

48. Use of the granulate according to claim 1 for earth retaining walls or roads.

49. Use of the granulate according to claim 1 as construction material in an area in contact with ground water, surface water or drinking water.

50. Use of the granulate according to claim 1 for hydraulic engineering.

51. Use of the granulate according to claim 1 for underground structures and in building construction.

52. Use of the granulate according to claim 1 for water renovation.

53. Use of the granulate according to claim 1 for producing a foam glass concrete or sintered glass concrete.

54. Use of the granulate according to claim 1 for destroying or binding endocrine toxins in waist water or drinking water.

55. Use of the granulate according to claim 28 for water renovation.

56. Use of the granulate according to claim 29 for water renovation.
